(19) United States
(12) Patent Application Publication
(10) Pub. No.: US 2004/0220801 A1
(43) Pub. Date: Nov. 4, 2004

(54) Pitch waveform signal generating apparatus, pitch waveform signal generation method and program

(76) Inventor: Yasushi Sato, Chiba (JP)

Correspondence Address: Robinson Intellectual Property Law Office, PMB 955, 21010 Southbank Street, Potomac Falls, VA, 20165, US

(21) Appl. No.: 10/415,415

(22) PCT Filed: Aug. 30, 2002
(86) PCT No.: PCT/JP02/08820

(30) Foreign Application Priority Data
Aug. 31, 2001 (JP) 2001-263395

(51) Int. Cl. G10L 11/04

(52) U.S. Cl. 704/207

(57) ABSTRACT

A computer filters voice data and specifies a pitch length based on a timing at which a filtering result zero-crosses. A center frequency of a pass band in filtering is controlled to a value equivalent to a reciprocal of the pitch length specified based on the zero-cross timing as long as a deviation from a pitch length extracted from a cepstrum of voice data and periodogram does not exceed a predetermined amount. Next, the computer divides the voice data based on the filtering result to unit pitches of segments and sets phases and sample numbers of individual segments constant to remove an influence of fluctuation of the pitch. Then, the acquired pitch waveform data is interpolated by plural schemes and that which has fewer harmonic components is output together with data indicating the original sample number and amplitude of each segment.

### TECHNICAL FIELD

The present invention relates to a pitch waveform signal generating apparatus, a pitch waveform signal generating method and a program.

BACKGROUND ART

In case where a voice signal is parameterized and handled, a voice signal is often treated as frequency information rather than waveform information. In voice synthesis, for example, many schemes using the pitch and formant of a voice are generally employed.

The pitch and formant will be described based on the process of generating a human voice. The generation process of a human voice starts with the generation of a sound consisting of a sequence of pulses by vibrating the vocal cord portion. This pulse is generated at a given period specific to each phoneme of a word and this period is called “pitch”. The spectrum of the pulse is distributed to a wide frequency band while containing relatively strong spectrum components which are arranged at intervals of the integer multiples of the pitch.

Next, as the pulse passes the vocal tract, the pulse is filtered in the space that is formed by the shapes of the vocal tract and tongue. As a result of the filtering, a sound which emphasizes only a certain frequency component in the pulse is generated. (That is, a formant is produced.) The above is the voice generation process.

As the vocal tract and tongue move, the frequency component to be emphasized in the pulse generated by the vocal tract changes. If this change is associated with a word, therefore, a voice speech is formed. In case where one wants to do voice synthesis, therefore, a synthesized voice having a voice quality with natural feeling can be acquired in principle if the filter characteristic of the vocal tract is simulated.

As a change in a human vocal tract is actually very complex, however, simulation of a human vocal tract is extremely difficult with the capability of an ordinary computer available. Therefore, the simulation of a human vocal tract should be executed on the assumption of a model which simplifies a vocal tract to a certain degree. Further, the pitch is likely to be influenced by the human feeling or consciousness and slightly fluctuates in reality while the pitch is a period which can be considered as constant to some degrees. Simulating such a change in pitch with a computer is hardly possible.

The conventional scheme that uses the pitch and formant of a voice therefore has an extreme difficulty in executing voice synthesis with a natural and real voice quality.

There is a voice synthesis scheme called “corpus system”. This scheme forms a database by classifying the waveforms of actual human voices for each phoneme and pitch and carrying out voice synthesis by linking those waveforms in such a way as to match with a text or the like. As this scheme uses the waveforms of actual human voices, natural and real voice qualities that cannot be obtained through simulation are acquired.

However, human voices generated have considerably multifarious patterns, and are nearly infinite with emotional expressions included. Therefore, the number of waveforms to be stored in the database would become huge. There is therefore a demand for a scheme of compressing the data amount in the database.

As the scheme of compressing the data amount in the database, there has been proposed a scheme which, in case where there is no waveform representing an original phoneme to be specified from a text or the like, selects a phoneme which can be best approximated to that phoneme.

Because even the execution of this scheme still makes the data amount of the database considerably large and synthesizes a voice by unnaturally linking phonemes which should not be used in the first place, there arises a problem such that a synthesized voice becomes unnatural with poor linkage.

In this respect, a scheme of compressing individual waveforms to be stored in the database is used as the scheme of compressing the data amount in the database. Conceivable scheme of compressing a waveform is to convert a waveform to a spectrum and remove those components which become difficult to be heard by a human due to the masking effect. Such a scheme is used in compression techniques, such as MP3 (MPEG1 audio layer 3), ATRAC (Adaptive TRansform Acoustic Coding) and AAC (Advanced Audio Coding).

However, the aforementioned fluctuation of a pitch raises a problem.

The spectrum of a voice generated by a human has a relatively strong spectrum arranged at intervals equivalent to the reciprocal of the pitch. If a voice does not have a pitch fluctuation, therefore, the aforementioned compression using the masking effect is executed efficiently. Because a pitch fluctuates with the feeling and consciousness (emotion) of a speaker, however, in case where the same speaker utters the same word (phonemes) by plural pitches, the pitch intervals are not normally constant. If voices that have actually uttered by a human are sampled by plural pitches to analyze the spectrum, therefore, the aforementioned relatively strong spectrum does not appear in the analysis result and compression using the masking effect based on such a spectrum cannot ensure efficient compression.

### DISCLOSURE OF INVENTION

The invention has been made in consideration of the above-described circumstances and aims at providing a pitch waveform signal generating apparatus and pitch waveform signal generating method that can accurately specify the spectrum of a voice whose pitch contains fluctuation.

To achieve the object, a pitch waveform signal generating apparatus according to the first aspect of the invention is characterized by comprising:

a filter (102, 6) which extracts a pitch signal by filtering an input voice signal;

phase adjusting means (102, 7, 8, 9) which divides the voice signal to segments based on the pitch signal extracted by the filter and adjusts a phase based on a correlation with the pitch signal in each of the segments;

sampling means (102, 11) which determines a sampling length based on the phase in each segment with the phase adjusted by the phase adjusting means and generates a sampling signal by performing sampling in accordance with the sampling length; and

pitch waveform signal generating means (102, 15) which generates a pitch waveform signal from the sampling signal based on a result of the adjustment by the phase adjusting means and a value of the sampling length.

The pitch waveform signal generating apparatus may further comprise filter coefficient determining means (102, 5) which determines a filter coefficient of the filter based on a reference frequency of the voice signal and the pitch signal, in which case the filter may change its filter coefficient with respect to a decision by the filter coefficient determining means.

The phase adjusting means may determine each of the segments by dividing a voice signal for each unit period of the pitch signal and, for each of the segments, may shift the phase to a phase acquired based on a correlation between signals to be obtained by shifting a phase of the voice signal to various phases and the pitch signal.

The phase adjusting means may have:

phase specifying means (102, 8) which determines each of the segments by dividing a voice signal for each unit period of said pitch signal and, for each of the segments, specifies a phase after phase shifting based on a correlation between signals to be obtained by shifting a phase of the voice signal to various phases and the pitch signal; and

means (102, 9) which shifts each of the segments to the phase specified by the phase specifying means and multiplies an amplitude of each of the segments by a constant to change the amplitude.

The constant is, for example, such a value that effective values of the amplitudes of the individual segments become a common constant value.

The pitch waveform signal generating means may generate the pitch waveform signal further based on the constant and a sample number of the sampling signal.

The phase adjusting means may divide the voice signal to the segments in such a way that a point at which a timing for the pitch signal extracted by the filter to become substantially 0 comes becomes a start point of the segments.

A pitch waveform signal generating apparatus according to the second aspect of the invention is characterized in that a pitch of a voice is specified (102, 7), a voice signal is divided to segments consisting of unit pitches of voice signals based on a value of the specified pitch (102, 8), and processes the voice signal to be a pitch waveform signal by adjusting a phase of a voice signal in each segment (102, 9).

A pitch waveform signal generating method apparatus according to the third aspect of the invention is characterized by:

extracting a pitch signal by filtering an input voice signal (102, 6);

dividing the voice signal to segments based on the extracted pitch signal and adjusting a phase based on a correlation with the pitch signal in each of the segments (102, 7,8,9);

determining a sampling length based on the phase in each segment with the phase adjusted and generating a sampling signal by performing sampling in accordance with the sampling length (102, 11); and

generating a pitch waveform signal from the sampling signal based on a result of the adjustment and a value of the sampling length (102, 15).

A computer readable recording medium according to the fourth aspect of the invention is characterized by having recorded a program for allowing a computer to function as:

a filter (102, 6) which extracts a pitch signal by filtering an input voice signal;

phase adjusting means (102, 7, 8, 9) which divides the voice signal to segments based on the pitch signal extracted by the filter and adjusts a phase based on a correlation with the pitch signal in each of the segments;

sampling means (102, 11) which determines a sampling length based on the phase in each segment with the phase adjusted by the phase adjusting means and generates a sampling signal by performing sampling in accordance with the sampling length; and

pitch waveform signal generating means (102, 15) which generates a pitch waveform signal from the sampling signal based on a result of the adjustment by the phase adjusting means and a value of the sampling length.

A computer data signal which is embedded in a carrier wave according to the fifth aspect of the invention is characterized by representing a program for allowing a computer to function as:

a filter (102, 6) which extracts a pitch signal by filtering an input voice signal;

phase adjusting means (102, 7, 8, 9) which divides the voice signal to segments based on the pitch signal extracted by the filter and adjusts a phase based on a correlation with the pitch signal in each of the segments;

sampling means (102, 11) which determines a sampling length based on the phase in each segment with the phase adjusted by the phase adjusting means and generates a sampling signal by performing sampling in accordance with the sampling length; and

pitch waveform signal generating means (102, 15) which generates a pitch waveform signal from the sampling signal based on a result of the adjustment by the phase adjusting means and a value of the sampling length.

A program according to the sixth aspect of the invention is characterized by allowing a computer to function as:

a filter (102, 6) which extracts a pitch signal by filtering an input voice signal;

phase adjusting means (102, 7, 8, 9) which divides the voice signal to segments based on the pitch signal extracted by the filter and adjusts a phase based on a correlation with the pitch signal in each of the segments;

sampling means (102, 11) which determines a sampling length based on the phase in each segment with the phase adjusted by the phase adjusting means and generates a sampling signal by performing sampling in accordance with the sampling length; and

pitch waveform signal generating means (102, 15) which generates a pitch waveform signal from the sampling signal based on a result of the adjustment by the phase adjusting means and a value of the sampling length.

### BRIEF DESCRIPTION OF DRAWINGS

FIG. 1 is a diagram illustrating the structure of a pitch waveform extracting system according to a first embodiment of the invention.

FIG. 2 is a diagram showing the flow of the operation of the pitch waveform extracting system in FIG. 1.

(a) and (b) of FIG. 3 are graphs showing the waveforms of voice data before being phase-shifted, and (c) is a graph representing the waveform of pitch waveform data

(a) of FIG. 4 is an example of the spectrum of a voice acquired by a conventional scheme, and (b) is an example of the spectrum of pitch waveform data acquired by the pitch waveform extracting system according to the embodiment of the invention.

(a) of FIG. 5 is an example of a waveform represented by sub band data obtained from voice data representing a voice acquired by a conventional scheme, and (b) is an example of a waveform represented by sub band data obtained from pitch waveform data acquired by the pitch waveform extracting system according to the embodiment of the invention.

FIG. 6 is a diagram illustrating the structure of a pitch waveform extracting system according to a second embodiment of the invention.

### BEST MODE FOR CARRYING OUT THE INVENTION

Embodiments of the invention will be described below with reference to the accompanying drawings.

### First Embodiment

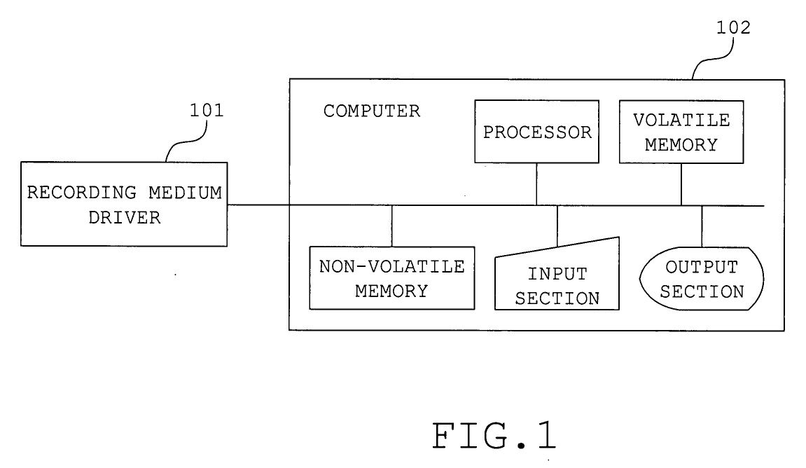

FIG. 1 is a diagram illustrating the structure of a pitch waveform extracting system according to the first embodiment of the invention. As illustrated, this pitch waveform extracting system comprises a recording medium driver (e.g., a flexible disk drive, MO (Magneto Optical disk drive) or the like) 101 which reads data recorded on a recording medium (e.g., a flexible disk, MO or the like) and a computer 102 connected to the recording medium driver 101.

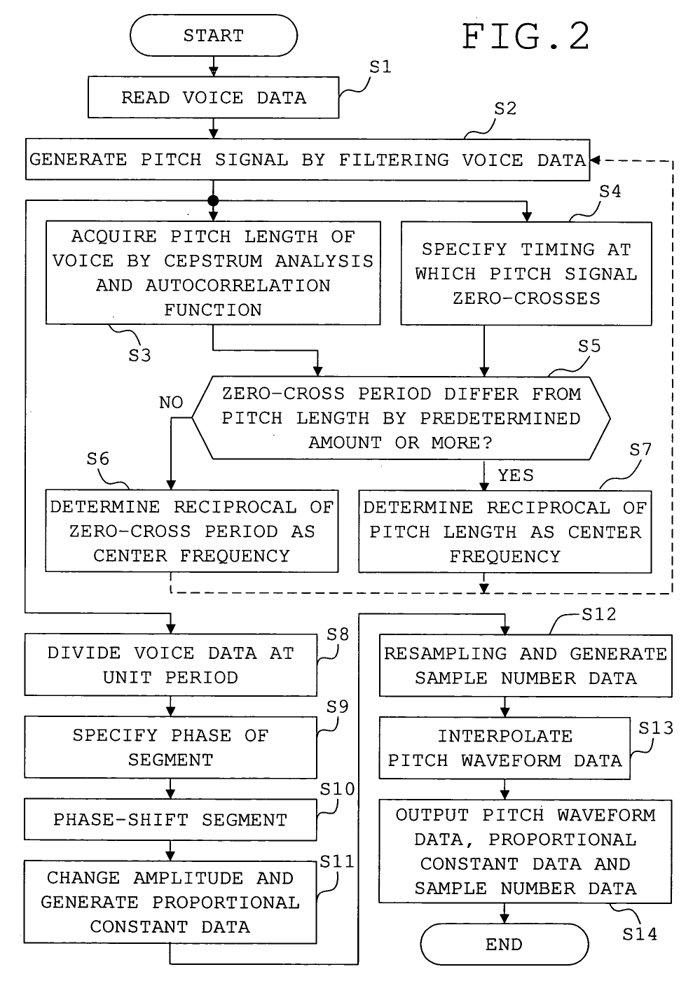

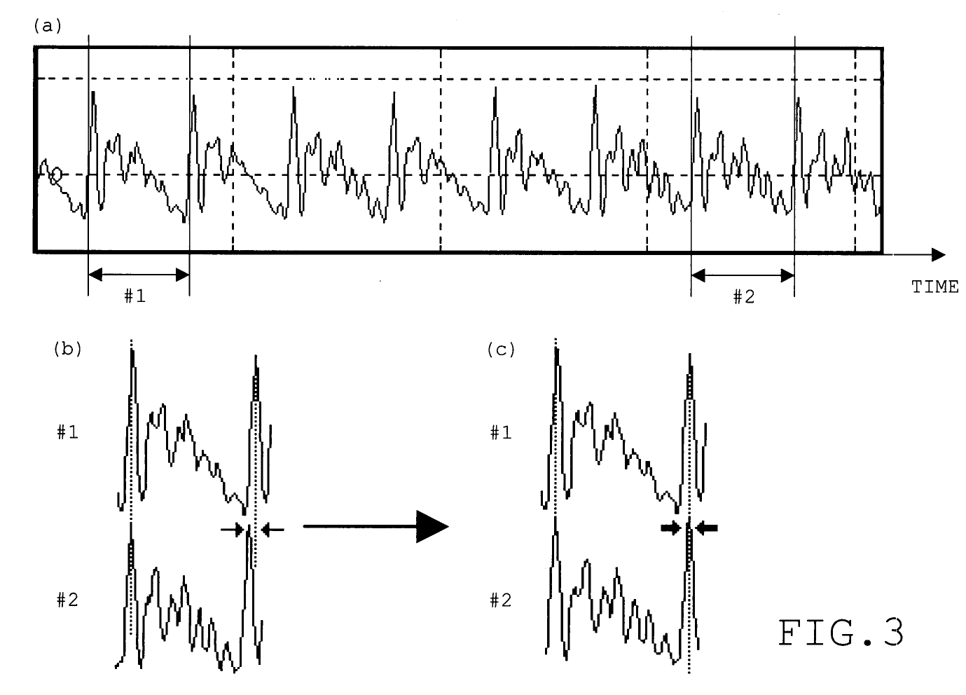

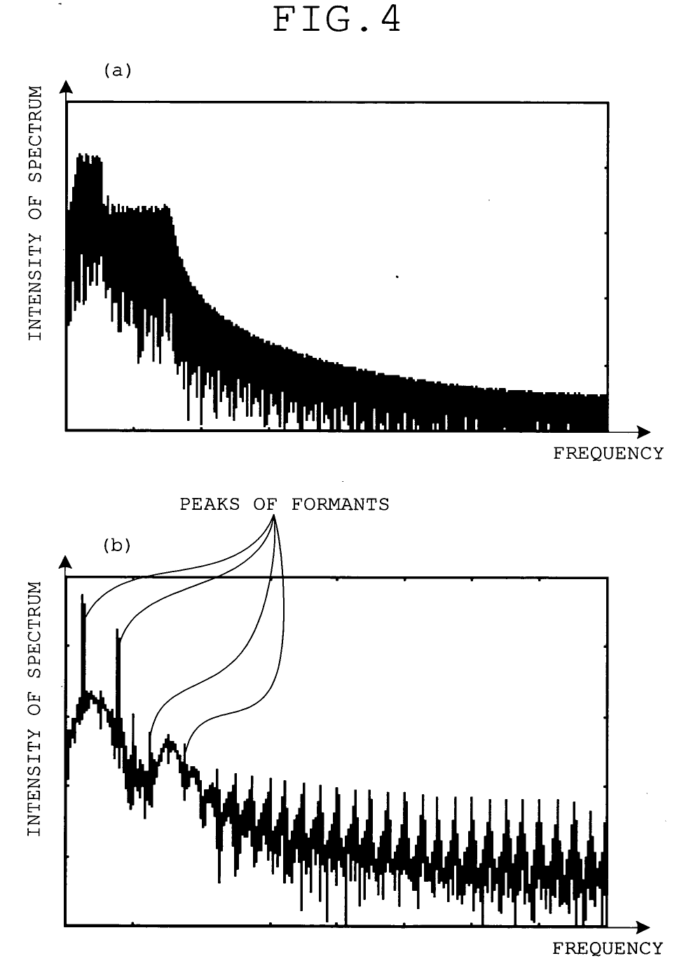

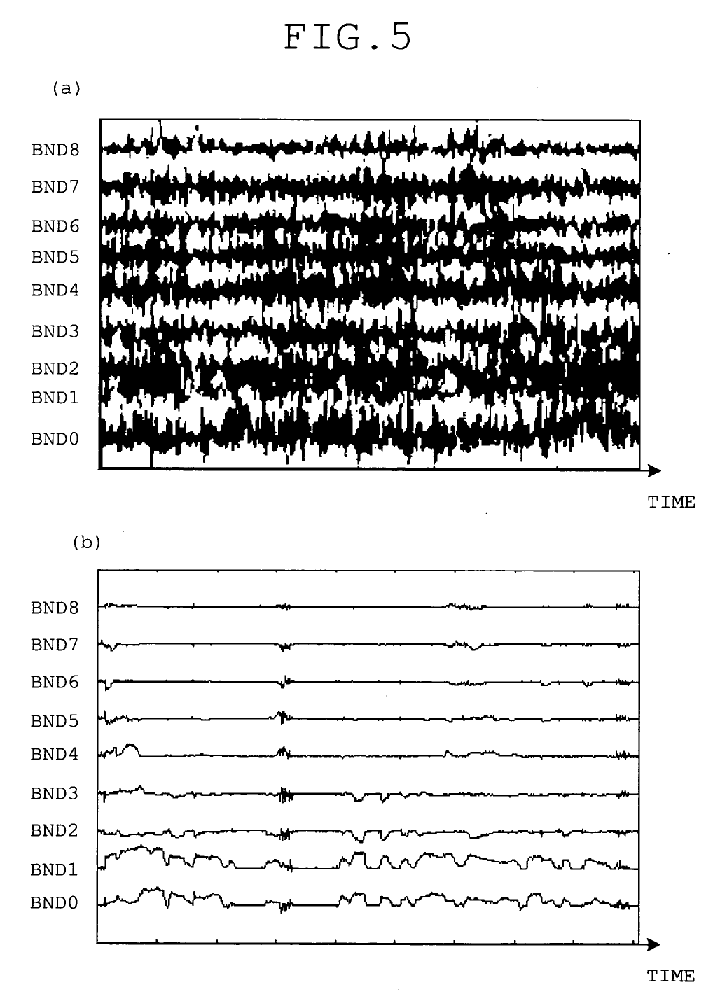

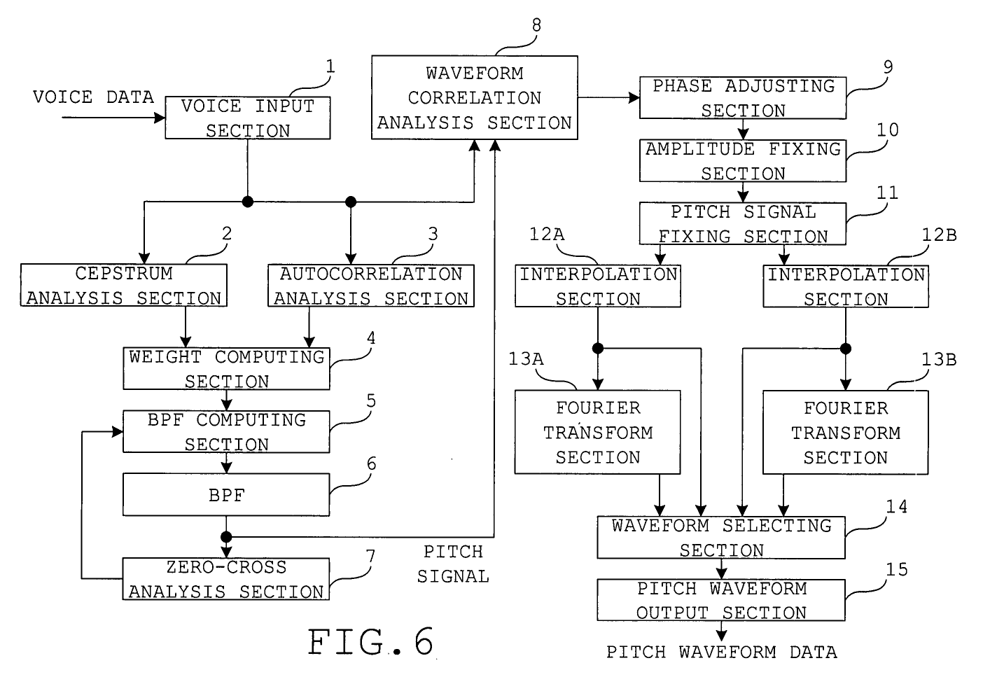

The computer 102 comprises a processor, comprised of a CPU (Central Processing Unit), DSP (Digital Signal Processor) or the like, a volatile memory, comprised of a RAM (Random Access Memory) or the like, a non-volatile memory, comprised of a hard disk unit or the like, an input section, comprised of a keyboard or the like, and an output section, comprised of a CRT (Cathode Ray Tube) or the like. The computer 102 has a pitch waveform extracting program stored beforehand and performs processes to be described later by executing this pitch waveform extracting program (First Embodiment: Operation) Next, the operation of the pitch waveform extracting program will be discussed referring to FIG. 2. FIG. 2 is a diagram showing the flow of the operation of the pitch waveform extracting system in FIG. 1.

As a user sets a recording medium on which voice data representing the waveform of a voice is recorded in the recording medium driver 101 and instructs the computer 102 to activate the pitch waveform extracting program, the computer 102 starts the processes of the pitch waveform extracting program.

Then, first, the computer 102 reads voice data from the recording medium via the recording medium driver 101 (Step 1 in FIG. 2). Note that it is assumed that voice data takes the form of a digital signal undergone PCM (Pulse Code Modulation) and represents a voice sampled at a given period sufficiently shorter than the pitch of the voice.

Next, the computer 102 generates filtered voice data (pitch signal) by filtering voice data read from the recording medium (step S2). It is assumed that a pitch signal is comprised of data of a digital form which has substantially the same sampling interval as the sampling interval of voice data.

The computer 102 determines the characteristic of filtering that is executed to generate a pitch signal by performing a feedback process based on a pitch length to be discussed later and a time (zero-crossing time) at which the instantaneous value of the pitch signal becomes 0.

That is, the computer 102 performs, for example, a cepstrum analysis or autocorrelation-function based analysis on the read voice data to thereby specify the reference frequency of a voice represented by this voice data and acquires the absolute value of the reciprocal of the reference frequency (i.e., a pitch length) (step S3). (Alternatively, the computer 102 may specify two reference frequencies by performing both of the cepstrum analysis and autocorrelation-function based analysis and acquire the average of the absolute values of the reciprocals of those two reference frequencies as the pitch length.)

In the cepstrum analysis, specifically, first, the intensity of read voice data is converted to a value substantially equal to the logarithm of the original value (the base of the logarithm is arbitrary), and the spectrum of the value-converted voice data (i.e., a cepstrum) is acquired by a fast Fourier transform scheme (or another arbitrary scheme which generates data representing the result of Fourier transform of a discrete variable). Then, the minimum value in those frequencies that give the peak values of the cepstrum is specified as a reference frequency.

In the autocorrelation-function based analysis, specifically, an autocorrelation function r(1) which is represented by the right-hand side of an equation 1 is specified first by using read voice data. Then, the minimum value which exceeds a predetermined lower limit value in those frequencies which give the peak values of the function (periodogram) that is obtained as a result of Fourier transform of the autocorrelation function r(1) is specified as a reference frequency. (It is to be noted that N is the total number of samples of voice data and x(α) is the value of the α-th sample from the top of the voice data.)

$$r ( l ) = \frac{1}{N} {\sum }_{t = 0}^{N - l - 1} \{ x ( t + 1 ) \cdot x ( t ) \} \qquad ( 1 )$$

Meanwhile, the computer 102 specifies the timing at which time for the pitch signal to zero-cross comes (step S4). Then, the computer 102 determines whether or not the pitch length and the zero-cross period of the pitch signal differ from each other by a predetermined amount or more (step S5), and when it is determined that they do not, the computer 102 performs the above-described filtering with the characteristic of a band-pass filter whose center frequency is the reciprocal of the zero-cross period (step S6). When it is determined that they differ by the predetermined amount or more, on the other hand, the above-described filtering is executed with the characteristic of a band-pass filter whose center frequency is the reciprocal of the pitch length (step S7). In either case, it is desirable that the pass band width of filtering should be such that the upper limit of the pass band always fall within double the reference frequency of a voice represented by voice data.

Next, the computer 102 divides voice data read from the recording medium at a timing at which the boundary of a unit period of the generated pitch signal (e.g., one period) comes (specifically, a timing at which the pitch signal zero-crosses) (step S8). Then, for each of segments obtained by division, the correlation between those which are obtained by variously changing the phase of voice data in this segment and the pitch signal in this segment is acquired and the phase of that voice data which provides the highest correlation is specified as the phase of voice data in this segment (step S9). Then, the segments of the voice data are phase-shifted in such a way that they become substantially in phase with one another (step S10).

Specifically, for each segment, the computer 102 acquires a value cor, which is represented by, for example, the right-hand side of an equation 2, in each of cases where φ representing the phase (where φ is an integer equal to or greater than 0) is changed variously. Then, a value Ψ of φ that maximizes the value cor is specified as a value representing the phase of the voice data in this segment. As a result, the value of the phase that maximizes the correlation with the pitch signal is determined for this segment. Then, the computer 102 phase-shifts the voice data in this segment by (−Ψ). (It is to be noted that n is the total number of samples in the segment, f(β) is the value of the β-th sample from the top of the voice data in the segment and g(γ) is the value of the γ-th sample from the top of the pitch signal in the segment)

$$cor = {\sum }_{i = 1}^{n} \{ f ( i - φ ) \cdot g ( i ) \} \qquad ( 2 )$$

FIG. 3(c) shows an example of the waveform that is represented by data (pitch waveform data) which is acquired by phase-shifting voice data in the above-described manner. Of the waveforms of voice data before phase shifting shown in FIG. 3(a), two segments indicated by “#1” and “#2” have different phases from each other due to the influence of the fluctuation of the pitch as shown in FIG. 3(b). By way of contrast, the segments #1 and #2 of the wave that is represented by pitch waveform data have the influence of the fluctuation of the pitch eliminated as shown in FIG. 3(c) and have the same phase. As shown in FIG. 3(a), the value of the start points of the individual segments are close to 0.

The time length of a segment should desirably be about one pitch. The longer a segment is, the greater the number of samples in the segment becomes, thus raising a problem such that the data amount of pitch waveform data increases or the sampling interval increases, making a voice represented by the pitch waveform data inaccurate.

Next, the computer 102 changes the amplitude by multiplying the pitch waveform data by a proportional constant for each segment and generates amplitude-changed pitch waveform data (step S11). In step S11, proportional constant data which indicates what value of the proportional constant is multiplied in which segment is also generated.

The proportional constant by which voice data is multiplied is determined in such a way that the effective values of the amplitudes of the individual segments of pitch waveform data become a common constant value. That is, in such a way that this constant value is J, the computer 102 acquires a value (J/K) which is the constant value is J divided by the effective value, K, of the amplitude of a segment of the pitch waveform data. This value (J/K) is the proportional constant to be multiplied in this segment. This determines the proportional constant for each segment of pitch waveform data.

Then, the computer 102 samples (resamples) individual segments of the amplitude-changed pitch waveform data again. Further, sample number data indicative of the original sample number of each segment is also generated (step S12).

It is assumed that the computer 102 performs resampling in such a way that the numbers of samples in individual segments of pitch waveform data become approximately equal to one another and the samples in the same segment are at equal intervals.

Next, the computer 102 generates data (interpolation data) representing a value to interpolate among samples of the resampled pitch waveform data (step S13). The resampled pitch waveform data and interpolation data constitute pitch waveform data after interpolation. The computer 102 may perform interpolation by, for example, the scheme of Lagrangian interpolation or Gregory-Newton interpolation.

Then, the computer 102 outputs the generated proportional constant data and sample number data and pitch waveform data after interpolation in association with one another (step S14).

The Lagrangian interpolation and Gregory-Newton interpolation are both interpolation schemes that can suppress the harmonic components of a waveform to relatively few. As both schemes differ from each other in the function that is used for interpolation between two points, however, the amount of harmonic components would differ between both schemes depending on the value of samples to be interpolated.

So, to take the advantages of both schemes, the computer 102 may use both schemes to further reduce the harmonic distortion of pitch waveform data.

Specifically, first, the computer 102 generates data (Lagrangian interpolation data) representing a value to be interpolated between samples of resampled pitch waveform data by the scheme of Lagrangian interpolation. The resampled pitch waveform data and the Lagrangian interpolation data constitute pitch waveform data after Lagrangian interpolation.

In the meantime, the computer 102 generates data (Gregory-Newton interpolation data) representing a value to be interpolated between samples of resampled pitch waveform data by the scheme of Gregory-Newton interpolation. The resampled pitch waveform data and the Gregory-Newton interpolation data constitute pitch waveform data after Gregory-Newton interpolation.

Next, the computer 102 acquires the spectrum of pitch waveform data after Lagrangian interpolation and the spectrum of pitch waveform data after Gregory-Newton interpolation by the scheme of fast Fourier transform (or another arbitrary scheme which generates data representing the result of Fourier transform of a discrete variable).

Next, based on the spectrum of the pitch waveform data after Lagrangian interpolation and the spectrum of the pitch waveform data after Gregory-Newton interpolation, the computer 102 determines which one of the pitch waveform data after Lagrangian interpolation and the pitch waveform data after Gregory-Newton interpolation has smaller harmonic distortion.

Resampling each segment of pitch waveform data may cause distortion in the waveform of each segment. As the computer 102 selects that of the pitch waveform data interpolated by plural schemes which minimizes the harmonic components, however, the amount of harmonic components included in the pitch waveform data that is output finally by the computer 102 is suppressed small.

The computer 102 may make a decision by acquiring effective values of components which are equal to or greater than double the reference frequency for each of the spectrum of the pitch waveform data after Lagrangian interpolation and the spectrum of the pitch waveform data after Gregory-Newton interpolation and specifying a smaller one of the acquired effective values as the spectrum of pitch waveform data with smaller harmonic distortion.

Then, the computer 102 outputs the generated proportional constant data and sample number data with one of the pitch waveform data after Lagrangian interpolation and the pitch waveform data after Gregory-Newton interpolation which has smaller harmonic distortion in association with one another.

The lengths and amplitudes of a unit pitch of segments of the pitch waveform data to be output from the computer 102 are standardized and the influence of the fluctuation of the pitch is removed. Therefore, a sharp peak indicating a formant is obtained from the spectrum of pitch waveform data so that the formant can be extracted from the pitch waveform data with a high precision.

Specifically, the spectrum of voice data from which the pitch fluctuation has not been removed does not have a clear peak and shows a broad distribution due to the pitch fluctuation, as shown in, for example, FIG. 4(a).

As pitch waveform data is generated from voice data having the spectrum shown in FIG. 4(a) by using this pitch waveform extracting system, on the other hand, the spectrum of this pitch waveform data becomes as shown in, for example, FIG. 4(b). As illustrated, the spectrum of the pitch waveform data contains clear peaks of formants.

Sub band data that is derived from voice data from which the pitch fluctuation has not been removed (i.e., data representing a time-dependent change in the intensity of an individual formant component represented by this voice data) shows a complicated waveform which repeats a variation in short periods, as shown in, for example, FIG. 5(a), due to the pitch fluctuation.

By way of contrast, sub band data that is derived from voice data from which indicates the spectrum shown in FIG. 4(b) shows a waveform which includes many DC components and has less variation as shown in, for example, FIG. 5(b).

A graph indicated as “BND0” in FIG. 5(a) (or FIG. 5(b)) shows a time-dependent change in the intensity of the reference frequency component of a voice represented by voice data (or pitch waveform data). A graph indicated as “BNDk” (where k is an integer from 1 to 8) shows a time-dependent change in the intensity of the (k+1)-th harmonic component of a voice represented by voice data (or pitch waveform data).

Because the influence of the pitch fluctuation is removed from the pitch waveform data output from the computer 102, a formant component is extracted from the pitch waveform data with a high reproducibility. That is, substantially the same formant component is easily extracted the pitch waveform data that represents a voice from the same speaker. In case where a voice is compressed by using a scheme which uses, for example, a code book, therefore, it is easy to use mixture of data of formants of the speaker which have been obtained in plural opportunities.

Further, the original time length of each segment of the pitch waveform data can be specified by using the sample number data and the original amplitude of each segment of the pitch waveform data can be specified by using the proportional constant data. It is therefore easy to restore the original voice data by restoring the length and amplitude of each segment of the pitch waveform data.

The structure of the pitch waveform extracting system is not limited to what has been described above.

For example, the computer 102 may acquire voice data from outside via a communication circuit, such as a telephone circuit, exclusive circuit or satellite circuit. In this case, the computer 102 should have a communication control section comprised of, for example, a modem or DSU (Data Service Unit) or the like. In this case, the recording medium driver 101 is unnecessary.

The computer 102 may have a sound collector which comprises a microphone, AF (Audio Frequency) amplifier, sampler, A/D (Analog-to-Digital) converter and PCM encoder or the like. The sound collector should acquire voice data by amplifying a voice signal representing a voice collected by its microphone, performing sampling and A/D conversion of the voice signal and subjecting the sampled voice signal to PCM modulation. The voice data that is acquired by the computer 102 should not necessarily be a PCM signal.

The computer 102 may supply proportional constant data, sample number data and pitch waveform data to the outside via a communication circuit. In this case too, the computer 102 should have a communication control section comprised of a modem, DSU or the like.

The computer 102 may write proportional constant data, sample number data and pitch waveform data on a recording medium set in the recording medium driver 101 via the recording medium driver 101. Alternatively, it may be written on an external memory device comprised of a hard disk unit or the like. In this case, the computer 102 should have a control circuit, such as a hard disk controller.

The interpolation schemes that are executed by the computer 102 are not limited to the Lagrangian interpolation and Gregory-Newton interpolation but may be other schemes.

The computer 102 may interpolate voice data by three or more kinds of schemes and select the one with the smallest harmonic distortion as pitch waveform data The computer 102 may have a single interpolation section to interpolate voice data with a single type of scheme and handle the data directly as pitch waveform data

Further, the computer 102 should not necessarily have the effective values of the amplitudes of voice data set equal to one another.

The computer 102 may not perform the cepstrum analysis or the autocorrelation-function based analysis, in which case the reciprocal of the reference frequency that is obtained by one of the cepstrum analysis and the autocorrelation-function based analysis should be treated directly as the pitch length.

The amount of voice data in each segment of the voice data that is phased-shifted by the computer 102 need not be (−Ψ); for example, the computer 102 may phase-shift voice data by (−Ψ+δ) in each segment where δ is a real number common to the individual segments which represents the initial phase. The position of voice signal at which the computer 102 divides the voice data should not necessarily be the timing at which the pitch signal zero-crosses, but may be a timing, for example, at which the pitch signal becomes a predetermined value other than 0.

If the initial phase α is 0 and voice data is divided at the timing at which the pitch signal zero-crosses, however, the value of the start point of each segment becomes close to 0, so that the amount of noise which is included in each segment becomes smaller by dividing voice data to the individual segments.

The computer 102 need not be an exclusive system but may be a personal computer or the like. The pitch waveform extracting program may be installed into the computer 102 from a medium (CD-ROM, MO, flexible disk or the like) where the pitch waveform extracting program is stored, or the pitch waveform extracting program may be uploaded to a bulletin board (BBS) of a communication circuit and may be distributed via the communication circuit. A carrier wave may be modulated with a signal which represents the pitch waveform extracting program, the acquired modulated wave may be transmitted, and an apparatus which receives this modulated wave may restore the pitch waveform extracting program by demodulating the modulated wave.

As the pitch waveform extracting program is activated under the control of the OS in the same way as other application programs and is executed by the computer 102, the above-described processes can be carried out. In case where the OS shares part of the above-described processes, a portion which controls that process may be excluded from the pitch waveform extracting program stored in the recording medium.

### Second Embodiment

FIG. 6 is a diagram illustrating the structure of a pitch waveform extracting system according to the second embodiment of the invention. As illustrated, this pitch waveform extracting system comprises a voice input section 1, a cepstrum analysis section 2, an autocorrelation analysis section 3, a weight computing section 4, a BPF coefficient computing section 5, a BPF (Band-Pass Filter) 6, a zero-cross analysis section 7, a waveform correlation analysis section 8, a phase adjusting section 9, an amplitude fixing section 10, a pitch signal fixing section 11, interpolation sections 12A and 12B, Fourier transform sections 13A and 13B, a waveform selecting section 14 and a pitch waveform output section 15.

The voice input section 1 is comprised of, for example, a recording medium driver or the like similar to the recording medium driver 101 in the first embodiment.

The voice input section 1 inputs voice data representing the waveform of a voice and supplies it to the cepstrum analysis section 2, the autocorrelation analysis section 3, the BPF 6, the waveform correlation analysis section 8 and the amplitude fixing section 10.

Note that voice data takes the form of a PCM-modulated digital signal and represents a voice sampled at a given period sufficiently shorter than the pitch of the voice.

Each of the cepstrum analysis section 2, the autocorrelation analysis section 3, the weight computing section 4, the BPF coefficient computing section 5, the BPF 6, the zero-cross analysis section 7, the waveform correlation analysis section 8, the phase adjusting section 9, the amplitude fixing section 10, the pitch signal fixing section 11, the interpolation section 12A, the interpolation section 12B, the Fourier transform section 13A, the Fourier transform section 13B, the waveform selecting section 14 and the pitch waveform output section 15 is comprised of an exclusive electronic circuit, or a DSP or CPU or the like.

All or some of the functions of the cepstrum analysis section 2, the autocorrelation analysis section 3, the weight computing section 4, the BPF coefficient computing section 5, the BPF 6, the zero-cross analysis section 7, the waveform correlation analysis section 8, the phase adjusting section 9, the amplitude fixing section 10, the pitch signal fixing section 11, the interpolation section 12A, the interpolation section 12B, the Fourier transform section 13A, the Fourier transform section 13B, the waveform selecting section 14 and the pitch waveform output section 15 may be executed by the same DSP or CPU.

This pitch waveform extracting system specifies the length of the pitch by using both cepstrum analysis and autocorrelation-function based analysis.

That is, first, the cepstrum analysis section 2 performs cepstrum analysis on voice data supplied from the voice input section 1 to specify the reference frequency of a voice represented by this voice data, generates data indicating the specified reference frequency and supplies it to the weight computing section 4.

Specifically, as voice data is supplied from the voice input section 1, the cepstrum analysis section 2 converts the intensity of this voice data to a value which is sufficiently equal to the logarithm of the original value first (The base of the logarithm is arbitrary.)

Next, the cepstrum analysis section 2 acquires the spectrum of the value-converted voice data (i.e., cepstrum) by a fast Fourier transform scheme (or another arbitrary scheme which generates data representing the result of Fourier transform of a discrete variable).

Then, the minimum value in those frequencies that give the peak values of the cepstrum is specified as a reference frequency and data indicating the specified reference frequency is generated and supplied to the weight computing section 4.

In the meantime, when voice data is supplied from the voice input section 1, the autocorrelation analysis section 3 specifies the reference frequency of a voice represented by voice data based on the autocorrelation function of the waveform of the voice data and generates and supplies data indicating the specified reference frequency to the weight computing section 4.

Specifically, when voice data is supplied from the voice input section 1, the autocorrelation analysis section 3 specifies the aforementioned autocorrelation function r(I) first. Then, the minimum value which exceeds a predetermined lower limit value in those frequencies which give the peak values of the periodogram that is acquired as a result of Fourier transform of the autocorrelation function r(l) is specified as the reference frequency, and data indicative of the specified reference frequency is generated and supplied to the weight computing section 4.

As a total of two pieces of data indicating reference frequencies are supplied, one each, from cepstrum analysis section 2 and the autocorrelation analysis section 3, the weight computing section 4 acquires the average of the absolute values of the reciprocals of the reference frequencies indicated by those two pieces of data. Then, data indicating the obtained value (i.e., the average pitch length) is generated and supplied to the BPF coefficient computing section 5.

As the data indicating the average pitch length is supplied from the weight computing section 4 and a zero-cross signal to be discussed later is supplied from the zero-cross analysis section 7, the BPF coefficient computing section 5 determines whether or not the pitch length, the pitch signal and the zero-cross period differ from one another by a predetermined amount or more. When it is determined that they do not differ so, the frequency characteristic of the BPF 6 is controlled in such a way that the reciprocal of the zero-cross period is set as the center frequency (the center frequency of the pass band of the BPF 6). When it is determined that they differ by the predetermined amount or more, on the other hand, the frequency characteristic of the BPF 6 is controlled in such a way that the reciprocal of the average pitch length is set as the center frequency.

The BPF 6 performs the function of an FIR (Finite Impulse Response) type filter whose center frequency is variable.

Specifically, the BPF 6 sets its center frequency to a value according to the control of the BPF coefficient computing section 5. Then, voice data supplied from the voice input section 1 is filtered and the filtered voice data (pitch signal) is supplied to the zero-cross analysis section 7 and the waveform correlation analysis section 8. The pitch signal is comprised of data which takes a digital form having substantially the same sampling interval as the sampling interval of voice data

It is desirable that the band width of the BPF 6 should be such that the upper limit of the pass band of the BPF 6 always falls within double the reference frequency of a voice representing voice data.

The zero-cross analysis section 7 specifies the timing (zero-crossing time) at which the instantaneous value of the pitch signal supplied from the BPF 6 becomes 0, and a signal representing the specified timing (zero-cross signal) is supplied to the BPF coefficient computing section 5. The length of the pitch of voice data is specified in this manner.

It is noted that the zero-cross analysis section 7 may specify the timing at which the instantaneous value of the pitch signal becomes a predetermined value other than 0, and supply a signal representing the specified timing to the BPF coefficient computing section 5 in place of the zero-cross signal.

The waveform correlation analysis section 8 is supplied with voice data from the voice input section 1 and supplied with a pitch signal from the waveform correlation analysis section 8, it divides the voice data at the timing at which the boundary of a unit period (e.g., one period) of the pitch signal comes. Then, for each of segments formed by the division, the correlation between those which are obtained by variously changing the phase of voice data in this segment and the pitch signal in this segment is acquired and the phase of that voice data which provides the highest correlation is specified as the phase of voice data in this segment The phase of voice data is specified for each segment in this manner.

Specifically, for each segment, the waveform correlation analysis section 8 specifies, for example, the aforementioned value Ψ, generates data indicative of the value Ψ and supplies it to the phase adjusting section 9 as phase data which represents the phase of voice data in this segment It is desirable that the time lengths of the segment phases should be for about one pitch.

When voice data is supplied from the voice input section 1 and data indicating the phase Ψ of each segment of voice data is supplied from the waveform correlation analysis section 8, the phase adjusting section 9 sets the phases of the individual phases equal to one another by phase-shifting the phase of the voice data in the individual segments by (−Ψ).

Then, the phase-shifted voice data (i.e., pitch waveform data) is supplied to the amplitude fixing section 10.

Next, as pitch waveform data is supplied from the phase adjusting section 9, the amplitude fixing section 10 changes the amplitude by multiplying this pitch waveform data by a proportional constant for each segment and supplies amplitude-changed pitch waveform data to the pitch signal fixing section 11. Further, proportional constant data which indicates what value of the proportional constant is multiplied in which segment is also generated and supplied to the pitch waveform output section 15. The proportional constant by which voice data is multiplied is determined in this manner. It is assumed that the proportional constant by which voice data is multiplied is determined in such a way that the effective values of the amplitudes of the individual segments of pitch waveform data become a common constant value.

As the amplitude-changed pitch waveform data is supplied from the amplitude fixing section 10, the pitch signal fixing section 11 samples (resamples) individual segments of the amplitude-changed pitch waveform data again, and supplies the resampled pitch waveform data to the interpolation sections 12A and 12B.

Further, the pitch signal fixing section 11 generates sample number data indicative of the original sample number of each segment and supplies it to the pitch waveform output section 15.

It is assumed that the pitch signal fixing section 11 performs resampling in such a way that the numbers of samples in individual segments of pitch waveform data become approximately equal to one another and the samples in the same segment are at equal intervals.

The interpolation sections 12A and 12B perform interpolation of pitch waveform data by using both of two types of interpolation schemes.

That is, as the resampled is supplied from the pitch signal fixing section 11, the interpolation section 12A generates data representing a value to be interpolated between samples of resampled pitch waveform data by the scheme of Lagrangian interpolation and supplies this data (Lagrangian interpolation data) together with the resampled pitch waveform data to the Fourier transform section 13A and the waveform selecting section 14.

The resampled pitch waveform data and the Lagrangian interpolation data constitute pitch waveform data after Lagrangian interpolation.

In the meantime, the interpolation section 12B generates data (Gregory-Newton interpolation data) representing a value to be interpolated between samples of the pitch waveform data, supplied from the pitch signal fixing section 11, by the scheme of Gregory-Newton interpolation, and supplies it together with the resampled pitch waveform data to the Fourier transform section 13B and the waveform selecting section 14. The resampled pitch waveform data and the Gregory-Newton interpolation data constitute pitch waveform data after Gregory-Newton interpolation.

As the pitch waveform data after Lagrangian interpolation (or the pitch waveform data after Gregory-Newton interpolation) is supplied from the interpolation section 12A (or 12B), the Fourier transform section 13A (or 13B) acquires the spectrum of this pitch waveform data by the scheme of fast Fourier transform (or another arbitrary scheme which generates data representing the result of Fourier transform of a discrete variable). Then, data representing the acquired spectrum is supplied to the waveform selecting section 14.

When pitch waveform data after interpolation which represent the same voice are supplied from the interpolation sections 12A and 12B and the spectra of those pitch waveform data are supplied from the Fourier transform sections 13A and 13B, the waveform selecting section 14 determines, based on the supplied spectra, which one of the pitch waveform data after Lagrangian interpolation and the pitch waveform data after Gregory-Newton interpolation has smaller harmonic distortion. Then, one of the pitch waveform data after Lagrangian interpolation and the pitch waveform data after Gregory-Newton interpolation which has been determined as having smaller harmonic distortion is supplied to the pitch waveform output section 15.

When the proportional constant data is supplied from the amplitude fixing section 10, the sample number data is supplied from the pitch signal fixing section 11 and the pitch waveform data is supplied from the waveform selecting section 14, the pitch waveform output section 15 outputs those three pieces of data in association with one another.

The lengths and amplitudes of a unit pitch of segments of the pitch waveform data to be output from the pitch waveform output section 15 are also standardized and the influence of the fluctuation of the pitch is removed. Therefore, a sharp peak indicating a formant is obtained from the spectrum of pitch waveform data so that the formant can be extracted from the pitch waveform data with a high precision.

Because the influence of the pitch fluctuation is removed from the pitch waveform data output from the pitch waveform output section 15, a formant component is extracted from the pitch waveform data with a high reproducibility.

Further, the original time length of each segment of the pitch waveform data can be specified by using the sample number data and the original amplitude of each segment of the pitch waveform data can be specified by using the proportional constant data.

The structure of the pitch waveform extracting system is not limited to what has been described above too.

For example, the voice input section 1 may acquire voice data from outside via a communication circuit, such as a telephone circuit, exclusive circuit or satellite circuit In this case, the voice input section 1 should have a communication control section comprised of, for example, a modem or DSU or the like.

The voice input section 1 may have a sound collector which comprises a microphone, AF amplifier, sampler, A/D converter and PCM encoder or the like. The sound collector should acquire voice data by amplifying a voice signal representing a voice collected by its microphone, performing sampling and A/D conversion of the voice signal and subjecting the sampled voice signal to PCM modulation. The voice data that is acquired by the voice input section 1 should not necessarily be a PCM signal.

The pitch waveform output section 15 may supply proportional constant data, sample number data and pitch waveform data to the outside via a communication circuit. In this case, the pitch waveform output section 15 should have a communication control section comprised of a modem, DSU or the like.

The pitch waveform output section 15 may write proportional constant data, sample number data and pitch waveform data on an external recording medium or an external memory device comprised of a hard disk unit or the like. In this case, the pitch waveform output section 15 should have a recording medium driver and a control circuit, such as a hard disk controller.

The interpolation that are executed by the schemes interpolation sections 12A and 12B are not limited to the Lagrangian interpolation and Gregory-Newton interpolation but may be other schemes. This pitch waveform extracting system may interpolate voice data by three or more kinds of schemes and select the one with the smallest harmonic distortion as pitch waveform data.

Further, this pitch waveform extracting system may have a single interpolation section to interpolate voice data with a single type of scheme and handle the data directly as pitch waveform data. In this case, the pitch waveform extracting system requires neither the Fourier transform section 13A or 13B nor the waveform selecting section 14.

Further, the pitch waveform extracting system should not necessarily have the effective values of the amplitudes of voice data set equal to one another. Therefore, the amplitude fixing section 10 is not the essential structure and the phase adjusting section 9 may supply the phase-shifted voice data to the pitch signal fixing section 11 immediately.

This pitch waveform extracting system should not necessarily have the cepstrum analysis section 2 (or the autocorrelation analysis section 3), in which case the weight computing section 4 may handle the reciprocal of the reference frequency that is acquired by the cepstrum analysis section 2 (or the autocorrelation analysis section 3) directly as the average pitch length.

The zero-cross analysis section 7 may supply the pitch signal, supplied from the BPF 6, as it is to the BPF coefficient computing section 5 as the zero-cross signal.

As described above, the invention realizes a pitch waveform signal generating apparatus and pitch waveform signal generating method that can accurately specify the spectrum of a voice whose pitch contains fluctuation.

The invention is not limited to the above-described embodiments but various modifications and applications are possible.

This patent application claims the priority of Japanese Patent Application No. 2001-263395 filed on Aug. 31, 2001 at the Japanese Patent Office under the Paris Convention, and the contents of this Japanese patent application are incorporated in this specification by reference.

1. A pitch waveform signal generating apparatus characterized by comprising:
a filter (102, 6) which extracts a pitch signal by filtering an input voice signal;
phase adjusting means (102, 7, 8, 9) which divides said voice signal to segments based on the pitch signal extracted by said filter and adjusts a phase based on a correlation with the pitch signal in each of the segments;
sampling means (102, 11) which determines a sampling length based on the phase in each segment with the phase adjusted by said phase adjusting means and generates a sampling signal by performing sampling in accordance with the sampling length; and
pitch waveform signal generating means (102, 15) which generates a pitch waveform signal from said sampling signal based on a result of the adjustment by said phase adjusting means and a value of said sampling length.

2. The pitch waveform signal generating apparatus according to claim 1, characterized by further comprising filter coefficient determining means (102, 5) which determines a filter coefficient of said filter based on a reference frequency of said voice signal and said pitch signal, and
in that said filter changes its filter coefficient with respect to a decision by said filter coefficient determining means.

3. The pitch waveform signal generating apparatus according to claim 1, characterized in that said phase adjusting means determines each of said segments by dividing a voice signal for each unit period of said pitch signal and, for each of said segments, shifts the phase to a phase acquired based on a correlation between signals to be obtained by shifting a phase of said voice signal to various phases and said pitch signal.

4. The pitch waveform signal generating apparatus according to claim 1, characterized in that said phase adjusting means has:
phase specifying means (102, 8) which determines each of said segments by dividing a voice signal for each unit period of said pitch signal and, for each of said segments, specifies a phase after phase shifting based on a correlation between signals to be obtained by shifting a phase of said voice signal to various phases and said pitch signal; and
means (102, 9) which shifts each of said segments to the phase specified by said phase specifying means and multiplies an amplitude of each of said segments by a constant to change the amplitude.

5. The pitch waveform signal generating apparatus according to claim 4, characterized in that said constant is such a value that effective values of the amplitudes of the individual segments become a common constant value.

6. The pitch waveform signal generating apparatus according to claim 5, characterized in that said pitch waveform signal generating means generates said pitch waveform signal further based on said constant and a sample number of said sampling signal.

7. The pitch waveform signal generating apparatus according to claim 1, characterized in that said phase adjusting means divides said voice signal to said segments in such a way that a point at which a timing for the pitch signal extracted by said filter to become substantially 0 comes becomes a start point of said segments.

8. A pitch waveform signal generating apparatus characterized in that a pitch of a voice is specified (102, 7), a voice signal is divided to segments consisting of unit pitches of voice signals based on a value of the specified pitch (102, 8), and processes said voice signal to be a pitch waveform signal by adjusting a phase of a voice signal in each segment (102, 9).

9. A pitch waveform signal generating method characterized by:
extracting a pitch signal by filtering an input voice signal (102, 6);
dividing said voice signal to segments based on the extracted pitch signal and adjusting a phase based on a correlation with the pitch signal in each of the segments (102, 7, 8, 9);
determining a sampling length based on the phase in each segment with the phase adjusted and generating a sampling signal by performing sampling in accordance with the sampling length (102, 11); and
generating a pitch waveform signal from said sampling signal based on a result of the adjustment and a value of said sampling length (102, 15).

10. A computer readable recording medium having recorded a program for allowing a computer to function as:
a filter (102, 6) which extracts a pitch signal by filtering an input voice signal;
phase adjusting means (102, 7, 8, 9) which divides said voice signal to segments based on the pitch signal extracted by said filter and adjusts a phase based on a correlation with the pitch signal in each of the segments;
sampling means (102, 11) which determines a sampling length based on the phase in each segment with the phase adjusted by said phase adjusting means and generates a sampling signal by performing sampling in accordance with the sampling length; and
pitch waveform signal generating means (102, 15) which generates a pitch waveform signal from said sampling signal based on a result of the adjustment by said phase adjusting means and a value of said sampling length.

11. A computer data signal which is embedded in a carrier wave and represents a program for allowing a computer to function as:
a filter (102, 6) which extracts a pitch signal by filtering an input voice signal;
phase adjusting means (102, 7, 8, 9) which divides said voice signal to segments based on the pitch signal extracted by said filter and adjusts a phase based on a correlation with the pitch signal in each of the segments;
sampling means (102, 11) which determines a sampling length based on the phase in each segment with the phase adjusted by said phase adjusting means and generates a sampling signal by performing sampling in accordance with the sampling length; and
pitch waveform signal generating means (102, 15) which generates a pitch waveform signal from said sampling signal based on a result of the adjustment by said phase adjusting means and a value of said sampling length.

12. A program for allowing a computer to function as:
a filter (102, 6) which extracts a pitch signal by filtering an input voice signal;
phase adjusting means (102, 7, 8, 9) which divides said voice signal to segments based on the pitch signal extracted by said filter and adjusts a phase based on a correlation with the pitch signal in each of the segments;
sampling means (102, 11) which determines a sampling length based on the phase in each segment with the phase adjusted by said phase adjusting means and generates a sampling signal by performing sampling in accordance with the sampling length; and
pitch waveform signal generating means (102, 15) which generates a pitch waveform signal from said sampling signal based on a result of the adjustment by said phase adjusting means and a value of said sampling length.
